(19) United States
(12) Patent Application Publication
(10) Pub. No.: US 2026/0257192 A1
(43) Pub. Date: Sep. 3, 2026

(54) REACTOR SYSTEM FOR A CARBONATION METHOD

(71) Applicant: CO-REACTIVE GMBH, Düsseldorf (DE)

(72) Inventors: Andreas Michael BREMEN, Hamburg (DE); Orlando Ramon KLEINEBERG, Düsseldorf (DE)

(73) Assignee: CO-REACTIVE GMBH, Düsseldorf (DE)

(21) Appl. No.: 19/165,095

(22) PCT Filed: Mar. 27, 2024
(86) PCT No.: PCT/EP2024/058334

§ 371 Date: Sep. 12, 2025

(30) Foreign Application Priority Data
Mar. 29, 2023 (DE) 102023108019.9

(51) Int. Cl. B01J 19/24; C04B 20/02; C04B 111/00

(52) U.S. Cl. CPC B01J 19/242; B01J 19/2425; C04B 20/0232; B01J 2219/00159; B01J 2219/00162; B01J 2219/185; C04B 2111/00019

(57) ABSTRACT

A reactor system for a continuous carbonation process comprising a plurality of at least ten substantially vertically arranged tubular reactors for performing a carbonation reaction, wherein the tubular reactors are operable at a pressure of ≥1 bar and wherein the tubular reactors comprise at least one media inlet through which a reaction mixture is introducible into the tubular reactors that are at a pressure of ≥1 bar, wherein the reactor system comprises a plurality of inlets for introducing gaseous or supercritical carbon dioxide into the tubular reactors and wherein the reactor system comprises a separation unit for substance and/or phase separation of a reaction mixture issuing from the tubular reactor.

The present invention relates to a reactor system for a carbonation process. The present invention further relates to a carbonation process performable in such a reactor system. The present invention moreover comprises the use of such a process or of such a reactor system for production of paints, cement or cement substitutes, of fillers, especially for paper products, polymer products or for concrete, and of products for roadbuilding.

Sequestration of carbon dioxide is a process known per se for removing carbon dioxide from the atmosphere or from process gases and for effecting secure binding thereof by chemical means. In detail, the sequestration of carbon dioxide involves for example ex-situ carbonation in which a carbonation reactant or constituents thereof are subjected to a chemical reaction with carbon dioxide in an aqueous solution. This especially serves the purpose of removing carbon dioxide from industrial processes or the atmosphere and effecting reliable and durable chemical binding thereof.

Andreas M. Bremen, Till Strunge, Hesam Ostovari, Hendrik Spütz, Adel Mhamdi, Phil Renforth, Mijndert van der Spek, André Bardow, and Alexander Mitsos, Direct Olivine Carbonation: Optimal Process Design for a Low-Emission and Cost-Efficient Cement Production, Industrial & Engineering Chemistry Research 2022 61 (35), 13177-13190 describes in this regard a process where a carbonation reaction is performed in a horizontal reactor.

DE 10 2021 116 491 A1 describes a carbonation process in which a reaction of a carbonation reactant is carried out in a reaction mixture with carbon dioxide to effect chemical binding of the carbon dioxide. Essential to this process is the addition to the reaction mixture of at least one nucleator on which at least one obtained reaction product is deposited, wherein the nucleator comprises at least one material that is a reaction product of the carbonation reactant with carbon dioxide.

WO 2021/009385 A1 describes a process for carbonation of carbon dioxide in which especially a threefold or twofold reduction or ideally a threefold or twofold avoidance of carbon dioxide emissions is intended to be achieved, namely by capturing the carbon dioxide formed from the air or in the production of molecular energy carriers in solids and also through the avoidance of carbon dioxide emissions through the use of these solids as a substitute for construction and/or chemical materials whose conventional production process traditionally leads to carbon dioxide emissions.

EP 2457638 A1 describes a plant and a process for treatment of CO₂ from a CO₂-emitting industrial plant comprising a CO₂ filter which is installed in a channel or another chamber, through which a stream of CO₂-containing gases from the industrial plant flows during operation, and which may be operated with or without vacuum. The CO₂ filter more particularly consist of plates or other bodies or pieces or of chips or another particulate or comminuted form of peridotitic mafic igneous rock or a material having a similar chemical composition selected for example from basalt, gabbro, dunite and amphibolites or from artificially produced materials based on Ca and Mg oxides having a similar chemical composition and similar properties to the recited naturally occurring mafic igneous rock materials.

WO 2014/082996 A1 describes a process for producing a second composition, wherein the process comprises the steps of: producing a first composition containing an alkali metal magnesium orthosilicate and optionally either (i) magnesium oxide or (ii) an alkali metal silicate and contacting the first composition with water to produce the second composition containing an amorphous magnesium silicate hydrate (M-S-H). In one embodiment, an alkaline solution produced in the process is contacted with a carbon dioxide-containing gas, for example combustion offgases, to absorb carbon dioxide and obtain an alkali metal carbonate, alkali metal bicarbonate or a mixture thereof, generally in solution, and obtain (precipitated) silicon dioxide.

WO 2011/035047 A2 describes a process for increasing activity of a water-containing magnesium silicate mineral with regard to mineral carbonic acid formation, wherein the process comprises thermal shock treatment of the mineral by very rapid heating. According to this document, it has proven possible to increase the activity of a certain class of starting material based on mineral carbon dioxide carbonation by heat treatment of the mineral according to a certain heat treatment regime. Accordingly, the rapid heating (thermal shocking) of a water-containing magnesium silicate mineral leads to modifications of the mineral which result in an elevated activity having regard to the mineral carbonation of carbon dioxide. In this context, the increase in activity relates to the mineral that was not subjected to such a heat treatment.

EP 2718230 B1 describes a process for mineralization of carbon dioxide to form a magnesium carbonate compound, wherein the process comprises the contacting of the carbon dioxide in free form or in the form of an alkali metal carbonate or bicarbonate with an alkali metal magnesium silicate to produce the magnesium carbonate compound.

US 2009/0305378 A1 describes a process for carbonation of minerals, characterized in that the silicate input material is thermally activated by using heat generated by the combustion of fuel before the activated slurry input material is reacted with carbon dioxide.

WO 2010/022468 A1 describes a process for converting carbon dioxide into solid material, wherein the process comprises the steps of: (a) direct thermal activation of mineral magnesium silicate hydroxide input material by combustion of fuel to produce an activated input material; (b) separation of metal oxides at least substantially excluding magnesium oxide and magnesium silicate from the activated input material to produce a residual activated input material; (c) before or after the separation step, suspending the activated input material in a solvent to form a slurry; and (d) contacting the slurry of the residual activated input material with carbon dioxide to convert the carbon dioxide into magnesium carbonate.

WO 2011/155830 A1 describes a process for converting metallic silicate minerals into silicon compounds and metal compounds by means of a conversion which is characterized in that the conversion is performed in a gravity pressure vessel (GPV), wherein: the gravity pressure vessel comprises two channels with separate inlets on the upper side of the gravity pressure vessel, wherein the channels on the lower side of the gravity pressure vessel are connected to one another and wherein the process comprises the steps of: providing a dispersion of solid particles of silicate minerals in water; conveying the provided dispersion through a first channel of the GPV in a downward direction to obtain a descending dispersion stream in the first channel; reacting the solid particles of silicate minerals in the dispersion with one or more reactants by addition of the reactants to the descending dispersion stream; and discharging the silicon compounds and metal compounds formed during the conversion through a second channel of the GPV in an ascending stream. It was surprisingly found that an efficient and energy-saving conversion with other additional advantages is achieved by using a gravity pressure vessel (GPV) and reacting the descending stream of silicate minerals with added reactants in the GPV.

US 2016/0166985 A1 describes a process for air purification in which especially carbon dioxide is to be removed from the air or the content thereof is to be reduced. The reduction in carbon dioxide is carried out using microalgae.

Such solutions known from the prior art may still have potential for improvement, especially with regard to improved sustainability.

It is accordingly an object of the present invention to provide a measure by which at least one problem of the prior art is at least partially overcome. It is especially an object of the present invention to provide a measure by which a carbonation process may be improved especially having regard to its sustainability.

According to the invention, the problem is solved by a reactor system having the features of claim 1. According to the invention, the problem is further solved by a process having the features of claim 12 and by a use having the features of claim 14. Preferred embodiments of the invention are disclosed in the subsidiary claims, in the description and in the example, wherein further features described or disclosed in the subsidiary claims or in the description or the example may represent subject matter of the invention individually or in any desired combination unless the contrary is clearly apparent from the context.

The present invention describes a reactor system for a continuous carbonation process comprising a plurality of substantially vertically arranged tubular reactors for performing a carbonation reaction, wherein the tubular reactors are operable at a pressure of ≥1 bar and wherein the tubular reactors comprise at least one media inlet through which a reaction mixture is introducible into the tubular reactors that are at a pressure of ≥1 bar, wherein the reactor system comprises at least one inlet for introducing carbon dioxide into the tubular reactors and wherein the reactor system comprises a separation unit for substance and/or phase separation of a reaction mixture issuing from the tubular reactor.

Such a reactor system particularly advantageously allows carbonation of a suitable reactant and thus the removal of carbon dioxide from process gases and from the atmosphere and especially permanent storage of the carbon dioxide in the reaction product of the carbonation process.

The reactor system described here thus serves a carbonation process and may especially be employed in a process for sequestration of carbon dioxide. In the context of the present invention, such a process is especially to be understood as meaning a process in which carbon dioxide reacts with a carbonation reactant or a constituent thereof and can therefore be bound in chemical form. The sequestration thus especially serves to remove carbon dioxide from the atmosphere or generally a gas or to avoid entry thereof and especially effect permanent storage thereof in chemically bound form. The process which may be performed in the reactor thus comprises a carbonation, such as for instance a mineral ex-situ carbonation, of the carbonation reactant.

The reactor system comprises a plurality of substantially vertically arranged tubular reactors for performing a carbonation reaction. At least two, for instance at least ten or else at least fifty, tubular reactors may be provided. A substantially vertical arrangement of the reactors shall especially be understood as meaning that these are arranged exactly vertically or in such a way that a gas can flow through the tube of the reactors as a result only of the buoyancy force. The vertical arrangement of the reactors likewise makes it possible to avoid sedimentation of the solids particles present in the flowing suspension. For example, a substantially vertical orientation may thus be an exactly vertical orientation having a maximum deviation of 60°, for example having a maximum deviation of 45°, for instance having a maximum deviation of 15°, to the vertical. For a space-saving arrangement especially all of the tubular reactors or at least a majority, for instance at least 75%, for instance at least 90%, may be arranged in parallel. It is thus possible for the material stream to enter on one side of the tubular reactor, to flow along its axis and to exit the tubular reactor again at the opposite side.

At least ten, for instance at least fifty, for example at least one hundred, tubular reactors may be provided, for example.

The tubular reactors are further preferably suitable for a high-pressure reaction and therefore operable at a pressure of ≥1 bar, for instance ≥20 bar, preferably ≥50 bar, particularly preferably ≥100 bar. This is advantageous since a carbonation reaction in particular may be run efficiently/allows a high conversion at high pressure. The substantially vertically arranged tubular reactors effect good phase commixing of solid, liquid phase and gas phase since phase separation is prevented by the parallelism of the flow direction and the gravitational force as the driving force for sedimentation. Commixing may be further improved by static mixers arranged in the reactors.

The tubular reactors comprise at least one media inlet through which a reaction mixture is introducible into the tubular reactors which are at a pressure of ≥1 bar. The reaction mixture may accordingly be introducible into a reactor when the reactor is at a pressure of ≥1 bar since this especially makes it possible to achieve a continuous process. The reaction mixture may especially be introducible into a reactor under operating pressure. The provision of a plurality of tubular reactors also makes it possible in the case of a vertical arrangement to ensure that the pressure level in the reactor is homogeneous, thus in turn making it possible to achieve a defined reaction.

The location at which the media inlet(s) is/are arranged may be selected according to the interconnection of the tubular reactors. In the case of parallel interconnection, each of the reactors may have a media inlet for introducing reaction mixture, while in the case of serial interconnection, only one reactor need have a corresponding initial media inlet since the reaction mixture can then also flow through the further reactors starting from the first reactor comprising the media inlet. However, the number of media inlets is in principle selectable, so that for example even in the case of serial interconnection a plurality or else each of the reactors may have a media inlet. It is also possible for further media inlets to be arranged at intervals of a certain reaction distance and thus after a possible reaction time.

However, it is advantageous when media inlet and media outlet are selected at at least one, preferably at all, tubular reactors in such a way that the reaction medium can at least partially, preferably completely, flow through the respective tubular reactor, which may be possible from bottom to top or else from top to bottom in light of the vertical arrangement. For example, a media inlet may be arranged at a bottom region, for instance at the bottom, of the respective tubular reactor and a media outlet may be arranged at a top region, for instance at the top, of the respective tubular reactor. The bottom region is the region in the lower half, for example in the lower third, preferably in the lower tenth, for instance at the lowest point, of the tubular reactor. Correspondingly, the top region is the region in the upper half, for example in the upper third, preferably in the upper tenth, for instance at the uppermost point, of the tubular reactor. This makes it possible for a mixture containing the reactant/the product, for instance suspension, to be passed through the respective tubular reactor, with the result that the whole tubular reactor constitutes the reaction volume. To this end, corresponding conveying means which convey the mixture, for instance pumps, are provided.

The reactor system further comprises at least one inlet for introducing carbon dioxide into the tubular reactors, especially in a gaseous or supercritical state. In this regard, both the number and the position of the inlets can in turn be selectable. For example, only one inlet may be provided or a plurality of inlets whose position is in principle selectable may be present. However, in the context of the present invention it is in principle important that the inlet(s) is/are positioned such that carbon dioxide can flow through the tubular reactors in an upward direction. To this end, the inlet(s) may be arranged for example in the lower half, for instance in the lower third, of the tubular reactors. In the case of a serial interconnection, the inlets may also be arranged for example between two reactors and be entrained with the reaction mixture. The inlets may be in the form of nozzles for example. They may either be permanently installed or in the case of wear or blockage be swappable/exchangeable and thus replaceable.

Introduction of carbon dioxide may entail for instance introduction of pure carbon dioxide or else introduction of a correspondingly diluted or else contaminated carbon dioxide. For example, carbon dioxide may be introducible in a mixture, for instance in a gas mixture, which mixture comprises at least 50% by weight, for instance at least 75% by weight, of carbon dioxide, for example at least 90% by weight.

It is further provided that the reactor system comprises a phase separator for phase separation of a reaction mixture issuing from the tubular reactor, for example to separate the solid or constituents thereof from the reaction mixture issuing from the tubular reactor. This makes it possible to remove reacted material, i.e. the reaction product, from the process stream, thus particularly advantageously allowing recirculation of the process stream through recycling of unseparated constituents of the reaction medium.

The substance separation or the phase separation may in principle be carried out by the separation unit by performing a basic operation, for example by filters hydrocyclones, classifying centrifuges or a combination of a plurality of basic operations. The separation unit may accordingly comprise for example a filter for filtering the reaction mixture or else a gas/liquid phase separator.

The reactor system described here exhibits clear advantages over solutions from the prior art.

A substantially vertical arrangement of the reactors can thus in particular allow a particularly efficient reaction. This is because dead volumes in which a gas accumulates but in which no reaction takes place can be prevented or at least markedly reduced. This likewise makes it possible to achieve a large reaction volume. It is accordingly possible to use substantially the entire reactor volume for the reaction.

This further makes it possible to carry out a very defined reaction since the reaction volume may be determined in a very defined manner, thus largely avoiding disruptive factors adversely affecting the reaction. The vertical arrangement further prevents sedimentation of the markedly heavier solid particles which in turn leads to good commixing and an efficient reaction. A further advantage of the vertical arrangement is that the introduced CO₂ flows either in cocurrent or countercurrent to the main flow in the form of bubbles and does not ascend perpendicularly thereto as in the horizontal arrangement. This makes it possible to achieve a comparatively long flow path of the carbon dioxide through the reactor which in turn allows a very efficient reaction.

Finally, the multiplicity of especially vertically arranged tubular reactors means that the reactor system allows simple interconnection of a plurality of reactors, thus in turn making it possible to achieve a very large reaction conversion in a relatively compact volume. The reactor system described here thus makes it possible to achieve a very adaptive and efficient system for performing a carbonation reaction.

A further advantage is that the temperature dissipation/heat dissipation to maintain the reaction temperature may be controlled very efficiently and exactly for a plurality of tubular reactors in particular. This further improves the possibility of providing defined reaction conditions and thus being able to perform the reaction efficiently and as desired.

This accordingly makes it possible to achieve a carbonation reaction with low energy input and high reaction conversion of carbon dioxide coupled with minimum volume and thus improved sustainability.

The reactor system may preferably comprise tubular reactors having different diameters or the reactor system may comprise at least one tubular reactor having a diameter of varying size. This embodiment may have an advantageous effect on the carbonation reaction taking place.

It has been found that the reaction is favoured if the system is subjected to temporary vigorous commixing and subsequently calmed again. In this embodiment, this is achieved in a continuous tube system with constant volume flow by altering the diameter or the cross section, thus increasing or reducing the flow rate and thus turbulence. This embodiment can thus have an advantageous effect on the solubility of the reactants and the products both as solid or as gaseous substances. A slow flow can also promote the crystal growth of the carbonates.

The diameter of the tubular reactors may in principle be in a range from ≥32 mm to ≤500 mm, for instance in a range from ≥100 mm to ≤250 mm, wherein the diameter refers to the internal diameter, i.e. the active reaction volume.

It is in principle possible to employ both a tubular reactor of varying diameter and different tubular reactors having diameters that are distinct from one another.

The reactor system may preferably be operable at a pressure of ≥1 bar downstream of the phase separator. In this embodiment, the region downstream of the phase separator/basic operation, i.e. purely by way of example the low-pressure side of the filter, is thus also operable at a pressure above atmospheric pressure. This embodiment makes it possible to advantageously realize recirculation, so that the reaction mixture to be recycled may be readily returned to the process. The reaction mixture may especially be recycled into one or more reactors. Exemplary pressures suitable for operating the region downstream of the phase separator, i.e. for instance between the phase separator and the tubular reactor, are for instance in the range of not less than 1 bar, for instance not less than 50 bar, preferably not less than 5 bar, below the pressure in the tubular reactor.

It may further be preferable when the phase separator allows passage of particles having a size in a range of ≤10 μm, for instance of ≤3 μm, for example of ≤1 μm. This embodiment makes it possible for particles to be recycled into the reaction process, said particles having a defined positive effect on this process. The recited values are to be regarded as merely exemplary.

In detail, it is noted that, after formation, the reaction products of the carbonation are conventionally also deposited on the surface of the carbonation reactant. This results in the formation of a passivation layer which increasingly impedes the reaction of the carbonation reactant with carbon dioxide, for instance by impeding or preventing dissolution of the corresponding cations from the carbonation reactant. This limits the conversion of the carbonation reactant.

By contrast, recycling the particles of defined size which pass through the phase separation has the result that reaction products from the carbonation reaction, for example corresponding carbonates or amorphous silicon dioxide, are predominantly deposited on the surface of the particles serving as nucleators, while the particles of the carbonation reactant remain substantially free of said products. This accordingly permits improved reaction management coupled with reduced inactivation.

The described embodiment thus makes it possible to achieve a particularly high conversion of the carbonation reactant. It is especially possible to efficiently prevent the formation of a passivation layer on the surface of the particles of the carbonation reactant from terminating the reaction thereof without the conversion having reached an advanced stage or even completion. It has been shown that especially particles that are in the aforementioned size range are effective as precipitation carriers for the products of the carbonation/the sequestration reaction. This may especially be because the small particle size entails a high specific surface area, thus resulting in effective nucleation. Furthermore, such small particles can especially ensure that damage to the coated nucleators during the reaction is avoided, thus further simplifying process management.

It may further be preferable to provide a comminution unit which makes it possible to comminute a solid starting product before introduction into the tubular reactor. This makes it possible to bring the starting products into a size suitable for the reaction and supply said products to the reaction via the media inlet directly in the reaction system. Suitable sizes comprise for instance ≤100 μm, for example ≤20 μm. A comminution unit may further comprise for example a cone crusher or a ball mill, wet milling may be used or further comminution units, for instance roller mills or pendulum mills, may be used.

The tubular reactors may preferably be part of a recirculation system. This makes it possible to perform a continuous process particularly efficiently. Reaction products may also have a positive effect in the process, for instance as nucleators, as described above.

It may further be preferable for the reactor system to comprise at least one processing unit for mechanical processing of solids present in the reaction stream, wherein the processing unit is arranged between two tubular reactors. Such a processing unit makes it possible to subject solids present to mechanical stress. This embodiment takes into account that product material may be deposited on the surfaces of the reactant particles in the course of the carbonation reaction. A resulting passivation layer on the reactant particles prevents complete reaction or at least markedly reduces reactivity. This passivation layer may further result from nonstoichiometric dissolution of the reactant, i.e. leaching of alkaline earth metals, with the result that an SiO₂-rich layer inhibits further dissolution since the dissolution reaction is then diffusion limited. A mechanical intermediate treatment breaks up the passivation layer and results in a higher conversion. This may be achieved by any unit which has a mechanical effect on the particles, for instance a gear pump. This would also have the synergistic effect of conveying the product stream, which can simplify the construction.

A sensor for the detection of gaseous constituents may further preferably be provided in the tubular reactor. In this embodiment, preferably at least one of the fill level of the aqueous mixture in the tubular reactor and the gas concentration in the aqueous mixture may accordingly be detected. Such a sensor may be used in particular to monitor the reaction taking place. This is because a sensor for detecting the fill level makes it possible to determine the height of the region of liquid or suspension and solid and/or the size of a potentially accumulating gas volume at the top of the reactors. The latter may for instance be made up of unreacted carbon dioxide, steam or inert gases present in the gas. Thus, especially this embodiment can ensure the above-described advantages with respect to a large reaction volume and a minimized dead volume. Determination of the gas concentration in the aqueous mixture can further determine for example whether there is sufficient gas present to allow the reaction to be performed as desired. An optimal value may be the saturation concentration so that no gas bubble is formed but the maximum amount of carbon dioxide is present in the aqueous phase. In this embodiment, suitable sensors comprise for example sensors for determining the density, conductivity, material concentration or pH in the medium. The values determinable in this way may be used to control the inflowing volume flow of the carbon dioxide. The carbon dioxide detected at the high points or at the top regions of the tubular reactors and accumulating as gas bubbles may, if present, optionally be recycled into the process.

A particularly preferred level of sustainability may be achieved when heat generated at the tubular reactor is reusable at another point in the process. This is readily possible for example using corresponding heat exchangers which transfer the heat generated at the tubular reactors for example to other positions. Heat transfer media can flow around the reactors for example and be passed to positions where the heat is needed. Reactant streams may be preheated for example to make the process particularly sustainable, with little energy input, or products may be dried.

In this embodiment in particular, it may be advantageous when at least one tubular reactor, preferably all of the tubular reactors present, is/are provided with a temperature control unit, wherein the temperature control unit comprises a fluid duct for conducting fluid temperature control medium which is conducted at the external circumference of the at least one tubular reactor.

In detail, a temperature control unit makes it possible to achieve a very good and exact temperature control in the tubular reactor system. The fluid duct is traversed by a heat transfer medium such as for instance air, water, heat transfer oil, etc. To this end, a conduction system is arranged around the tubular reactors for instance. By way of example, the tubular reactors are surrounded by a jacket as a fluid duct and the jacket has one or more inlets and outlets for the heat transfer medium. Optional baffles allow the heat transfer medium to be passed along the pipes. This has the advantage that an ideal and very homogeneous temperature prevails over the entire reactor. The homogeneous temperature is especially achieved by the multiplicity of tubular reactors having a very high specific surface area, thus allowing very good heat transfer. The fluid heat transfer medium may be heated via external heating, for instance during startup of the reactors, and cooled during operation to dissipate the exothermic heat during the reaction. The latter may be highly advantageous especially for the above-described thermal recovery.

It may further be provided that at least one of a decompression unit, for at least partial decompression of the process stream, and a gas separator, especially for separation of gas present in the process stream and/or for absorbing pressure variations or pressure peaks, is provided upstream of the separation unit. This embodiment makes it possible to prevent entrainment of gas present in the process stream, for instance carbon dioxide, carrier gas or any steam present. On the contrary, such gas can be efficiently removed from the process stream. For example, carbon dioxide may then be isolated from a gas mixture and resupplied to the reaction or the removed gas may be recycled to the process without further purification. Suitable gas separators or decompression units known per se may be used to this end for example.

The plurality of tubular reactors may be connected in series for example. The reaction mixture may therefore pass through all of the reactors. This embodiment allows a particularly long reaction time and thus an effective reaction.

It is also possible for the plurality of tubular reactors to be connected in parallel. In this embodiment, a relatively large amount of carbon dioxide may be converted in a short time.

According to the invention, the reactor system may also be configured such that it is possible to switch between a parallel and serial interconnection and vice versa. This is possible in a manner known per se using corresponding interconnection units.

Having regard to further technical features or advantages of the reactor system, reference is made to the description of the carbonation process, the use, the FIGURES and the description of the FIGURES, and vice versa.

The invention further describes a continuous carbonation process comprising the process steps of:
a) providing a carbonation reactant, wherein the carbonation reactant is suitable for reacting with carbon dioxide;
b) providing carbon dioxide, especially in a gaseous or supercritical state; and
c) performing a reaction of the carbonation reactant with carbon dioxide to effect chemical binding of the carbon dioxide, wherein process step c) is performed in a reaction system as described above.

The process described here is a carbonation process and may especially be used in or may constitute a process for sequestration of carbon dioxide. In the context of the present invention, such a process is especially to be understood as meaning a process in which carbon dioxide reacts with a carbonation reactant or a constituent thereof and can therefore be bound in chemical form. Sequestration is therefore especially used to remove carbon dioxide from process gases or the atmosphere or in principle a gas and to especially effect permanent storage thereof in chemically bound form. The process thus comprises a carbonation, such as a mineral ex-situ carbonation, of the carbonation reactant.

To this end, the process comprises, according to process step a), providing a carbonation reactant, wherein the carbonation reactant is suitable for reacting with carbon dioxide. In the context of the present invention and as is comprehensible to a person skilled in the art, a reaction of the carbonation product with carbon dioxide is to be understood as meaning that the carbonation reactant as a whole or parts thereof can react with carbon dioxide to chemically bind carbon dioxide. For example, individual ions, especially cations, present in the carbonation reactant can react with carbon dioxide and form the corresponding carbonates for example.

The carbonation reactant can thus in principle be freely selectable and is in principle not limited provided a reaction with carbon dioxide as described above can be enabled.

However, it may be preferable for the carbonation reactant to comprise at least one material which is selected from the group consisting of oxides and silicates of alkali metals and alkaline earth metals, especially calcium- or magnesium-containing solids. Such carbonation reactants are particularly well-suited for binding carbon dioxide since the metal cations may usually readily be brought into solution and a reaction to afford the corresponding carbonates or amorphous silicon dioxide is moreover efficiently possible. These materials are also usually readily available, either as minerals/rocks, for instance comprising peridodites, olivines, basalt, materials from the serpentine group or else secondary raw materials, for instance comprising slags, fly ashes, filter dusts and mining wastes or processing tailings.

However, it is, in principle, possible to employ any material known from the prior art for carbonation.

The carbonation reactant may further be mixed especially with a liquid carrier, for instance with water, before it is supplied to a reaction. To this end, it is possible to provide a mixer having a high-pressure metered addition unit through which the reactant or the reactant stream is suppliable to a reaction such as for instance a reactor. Additives, such as NaCl, NaHCO₃, NaOH and/or organic acids or bases, may also be admixed.

According to process step b), the process described here further comprises providing carbon dioxide, especially in a gaseous or supercritical state. Carbon dioxide may be provided in suitable purity so that it is introducible into a reactor in which the carbonation reaction is performed. The carbon dioxide may for example be provided in gaseous form in a carrier gas, such as especially an inert gas, for instance argon or nitrogen. The carbon dioxide may be present for instance in a proportion in the gas mixture of ≥15% by weight to ≤100% by weight and supplied to the reaction. Carbon dioxide may be employed for example in a content of at least 50% by weight, for instance at least 75% by weight, for example at least 90% by weight.

Accordingly, the process comprises the further process step c), namely performing a reaction of the carbonation reactant in a reaction mixture with carbon dioxide to effect chemical binding of the carbon dioxide. The carbon dioxide of the reaction mixture may for example be specifically supplied so as to come into contact with the carbonation reactant or the reactive constituents thereof. To this end, the reaction mixture may be under a positive pressure of carbon dioxide, for instance. It is preferable when the reaction mixture comprising the solid reactant and product traverses the tubular reactors ideally substantially completely, wherein the gas may be run in cocurrent or countercurrent.

The reaction mixture known from the prior art may be for example an aqueous mixture, such as for instance a dispersion, to which the carbonation reactant is added and in which the cations of the carbonation reactant go into solution. Especially alkali metal cations or alkaline earth metal cations of the carbonation reactant may go into solution in order thus to be able to react with the carbon dioxide.

This is possible for instance using an aqueous reaction mixture and with addition of an acid or base so that the pH of the aqueous mixture is correspondingly adjusted. One or more acids and/or one or more bases and/or one or more chelate formers may thus in principle be added to the reaction mixture, wherein the addition of further additives is in principle not excluded. Further parameters, such as for instance a suitable reaction temperature and/or a suitable partial pressure of the carbon dioxide, may additionally be adjusted so that the carbonation to form corresponding reaction products is effected in an economic timeframe. The adjustment of such parameters as well as the basic implementation of such a carbonation is known in principle to those skilled in the art.

An exemplary and non-limiting reaction equation of a carbonation reaction which may be carried out in the context of the present invention corresponds to the following equation:

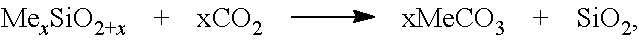

wherein Me is an alkali metal or alkaline earth metal and wherein x represents the number of the respective atoms in the chemical compound, so that x is dependent on the employed carbonation reactant in a manner comprehensible to those skilled in the art.

According to the invention, the process described above is performed in a reactor system as described above. This results essentially in the advantages as described above with reference to the reactor system.

It is preferable when reaction product obtained after process step c) may be removed from the reaction system using a separation unit, wherein particles up to a defined size range as a constituent of the material stream downstream of the separation unit, for example a filtrate, are reused in process step c). For example, it is possible to recycle particles having a maximum size in a range of ≤3 μm. These may particularly advantageously serve as nucleators in the reaction and thus positively affect the reaction.

In detail, the process described here can make it possible to effect a particularly efficient and sustainable reaction with a high conversion.

Having regard to further technical features and advantages of the carbonation process, reference is made to the description of the reactor system, the use, the FIGURES and the description of the FIGURES and vice versa.

The invention further describes the use of a process or a reactor system as described above for the production of cement or cement substitutes, of fillers, especially for paper products, polymer products or for concrete, or of products for roadbuilding. It has been shown that the advantages of the invention are brought to bear particularly effectively in the production of such products, in particular. The CO₂ footprint may thus be significantly reduced, particularly in the production of such products.

Having regard to further technical features and advantages of the use, reference is made to the description of the reactor system, the carbonation process, the FIGURES and the description of the FIGURES and vice versa.

The invention shall now be elucidated by way of example with reference to the appended drawing, wherein the features shown below may represent an aspect of the invention each individually or in combination and wherein the invention is not restricted to the following drawing, the following description and the following exemplary embodiment.

In the FIGURES:

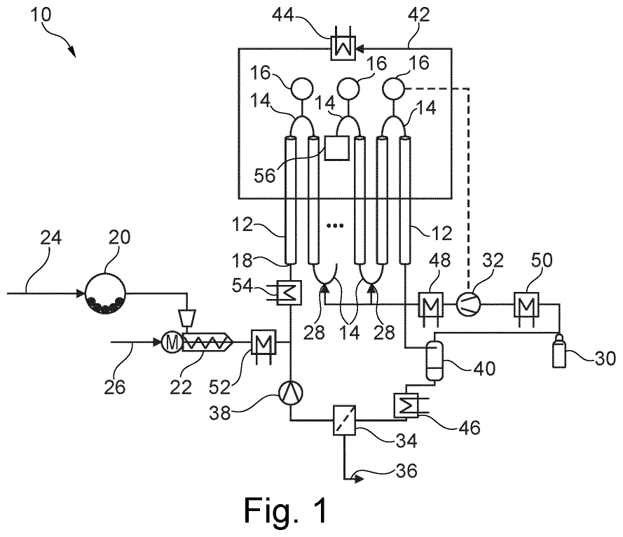

FIG. 1 shows a schematic view of a reactor system according to an exemplary embodiment of the present invention.

FIG. 1 shows a reactor system 10 for a continuous carbonation process. The reactor system 10 comprises a plurality of substantially vertically arranged tubular reactors 12 which in the embodiment according to FIG. 1 are arranged in series via interposed connecting regions 14 which may be in the form for instance of pipe conduits or of U-pipes. The tubular reactors 12 are operable at a pressure of ≥1 bar to obtain an advantageous conversion as is described in more detail hereinbelow. Provided at the top-end connecting regions 14 are respective sensors 16 for detection of gaseous constituents in the tubular reactor 12.

Provided at the first tubular reactor 12 in the flow direction is a media inlet 18 through which a reaction mixture is introducible into the tubular reactors 12 which are at a pressure of ≥1 bar.

To introduce the reaction mixture, a rock mill is provided as a comminution unit 20 which makes it possible to comminute a reactant. The reactant, such as for instance an oxide of an alkaline earth metal, may be mixed with water and additives and introduced into the reactors 12 via a high-pressure metered addition unit 22, such as for instance a piston pump, press or screw. The introduction of the raw reactant is intended to be indicated by the arrow 24 and the introduction of the aqueous phase optionally containing additives by the arrow 26.

The reactor system 10 further comprises a plurality of inlets 28 for introducing especially gaseous or supercritical carbon dioxide into the tubular reactors 12. According to FIG. 1, these inlets 28 are arranged on connecting regions 14 arranged at the bottom region of the tubular reactors 12. The inlets 28 may alternatively also be arranged directly on the tubular reactors 12. The for instance gaseous carbon dioxide may be withdrawn from a carbon dioxide source 30, for instance a pressure vessel, and supplied by a compressor 32 or a pump to the tubular reactors 12 or the inlets 28, for instance nozzles. In addition to the supply of CO₂, the inlets 28 may be used for the supply of additives, for instance of acids and bases, to make CO₂ available to the reaction and adjust the pH of the aqueous solution to the reaction requirements.

A processing unit 56 for mechanical processing of solids present in the reaction stream is also provided between two tubular reactors 12. These make it possible to break up passivation layers on the particles, which can further increase reactivity. A comminution of particles, both reactant and product particles, can also function as further nucleators.

It is further apparent from FIG. 1 that the process stream may be recirculated. For example, in such a circuit, the reaction mixture upstream of the reaction and the mixture downstream of the reaction/the material stream present in the circuit may thus be described as the process stream.

To make this possible in advantageous fashion and especially to remove reaction products or residues of the reactant from the material stream, a separation unit (34) used for substance separation and/or phase separation is provided. The separation unit accordingly makes it possible to achieve at least one operation of a substance separation and a phase separation. This accordingly makes it possible to achieve a substance separation of reaction product and reaction medium of a reaction mixture issuing from the tubular reactor 12. The separation unit 34 is based for example on a substance separation by a basic operation or a combination of a plurality of basic operations, such as filtration for instance using a high-pressure filter, vacuum filter or drum filter, a tube press, a hydrocyclone or a classifying centrifuge. The reactor system 10 downstream of the separation unit 34 may further be operable at a pressure of ≥1 bar. The separation unit 34 may further allow passage of particles having a size in a range of for instance ≤10 μm. Smaller particles partly remain in the aqueous solution and thus form a suspension. These particles consist of unreacted reactant and product particles which can act as nucleators in the reaction after recirculation.

In principle, a plurality of basic operations for the phase separation and/or substance separation of the separation unit 34 may be connected in parallel for example and are then sequentially active to remove or purify the solids in case of inactive basic operations. This makes it possible to achieve an economic process through reduced energy input for heating and compression of recycled process streams. The separated solids may be discharged as indicated by the arrow 36. The remaining reaction medium may be returned to the media inlet 18, for instance via a conveying pump 38.

A gas separator 40 is further provided upstream of the separation unit 34. The gas separator 40 is used to separate gas present in the process stream for example. A gas separator may also be advantageous since it can make it possible to keep the pressure in the system stable via a gas cushion for instance. This makes it possible to prevent pressure variations and pressure surges.

FIG. 1 also shows that heat generated in the tubular reactors 12 is reusable at another point in the process. This is made possible by providing a plurality of heat exchangers. This makes it possible to achieve the great advantage that over the large surface area of the tubular reactors 12 the heat output formed by the exothermic chemical process may be dissipated, thus ensuring constant reaction conditions over the entire length. A heat transfer medium, such as for instance air, water, oil, etc., may be used to absorb the heat and resupply it at another point in the process.

The heat exchanger 44 is optional and the heat transfer medium may also be directly contacted with the other heat transferrers, for instance heat exchangers. It is further possible to cool the process medium upstream of the separation unit 34, for instance by the heat exchanger 46, and to use the heat in the carbon dioxide compression, for instance via the heat exchangers 48, 50. This heat output and the heat output of the tubular reactors 12 may be utilized to preheat the supplied reactant material especially comprising rock, water and additives, for instance via the heat exchangers 52, 54, or to dry the separated product material.

The reactor system 10 shown thus comprises substantially continuously operated tubular reactors 12 which are operated at high pressure and temperature and the periphery which effects targeted introduction and discharge of media into and from the reactor under reaction conditions as well as milling, separation, conveying, compression, separation and mixing. The chemical reaction of gaseous CO₂ to afford solid carbonate performable therein (CO₂ mineralisation for instance in magnesium or calcium-containing solids) may be performable very efficiently and sustainably. The possible continuous operation is time-saving, since setup times of a batch process are avoided, and energy-saving, since not every reaction run requires energy to be expended to adjust the required pressure and temperature.

The energy-efficient process described herein and performable in the reactor system 12 according to the invention makes it possible to achieve cost-effective production of a product such as for instance for paints, cement or cement substitutes, fillers, especially for paper products, polymer products or for concrete, or products for roadbuilding while simultaneously reducing the CO₂ emissions of the mineralization process. For example, the present invention makes it possible to significantly reduce the CO₂ footprint in cement, for example by using the produced material as a substitute in cement.

### REFERENCE NUMERALS

10 Reactor system
12 Tubular reactor
14 Connecting region
16 Sensor
18 Media inlet
20 Comminution unit
22 High-pressure metered addition unit
24 Arrow
26 Arrow
28 Inlet
30 Carbon dioxide source
32 Compressor
34 Separation unit
36 Arrow
38 Conveying pump
40 Gas separator
42 Arrow
44 Heat exchanger
46 Heat exchanger
48 Heat exchanger
50 Heat exchanger
52 Heat exchanger
54 Heat exchanger
56 Processing unit

1. A reactor system for a continuous carbonation process comprising a plurality of substantially vertically arranged tubular reactors for performing a carbonation reaction, wherein the tubular reactors are operable at a pressure of ≥1 bar and wherein the tubular reactors comprise at least one media inlet through which a reaction mixture is introducible into the tubular reactors that are at a pressure of ≥1 bar, wherein the reactor system comprises at least one inlet for introducing carbon dioxide into the tubular reactors and wherein the reactor system comprises a separation unit for substance and/or phase separation of a reaction mixture issuing from the tubular reactor.

2. The reactor system according to claim 1, wherein the reactor system comprises tubular reactors having different diameters or in that at least one tubular reactor has a diameter of varying size.

3. The reactor system according to claim 1, wherein the reactor system downstream of the separation unit is operable at a pressure of ≥1 bar.

4. The reactor system according to claim 1, wherein a comminution unit which makes it possible to comminute a solid starting product before introduction into the tubular reactor is provided.

5. The reactor system according to claim 1, wherein the reactor system comprises at least one processing unit for mechanical processing of solids present in the reaction stream, wherein the processing unit is arranged between two tubular reactors.

6. The reactor system according to claim 1, wherein at least one sensor for detection of gaseous components is provided in at least one tubular reactor.

7. The reactor system according to claim 1, wherein heat generated at the tubular reactor is reusable at another point in the reactor system.

8. The reactor system according to claim 1, wherein at least one tubular reactor is provided with a temperature control unit, wherein the temperature control unit comprises a fluid duct for conducting fluid temperature control medium which is conducted at the external circumference of the at least one tubular reactor.

9. The reactor system according to claim 1, wherein at least one of a decompression unit for at least partial decompression of the process stream and a gas separator is provided upstream of the separation unit.

10. The reactor system according to claim 1, wherein the plurality of tubular reactors is connected in series.

11. The reactor system according to claim 1, wherein the plurality of tubular reactors is connected in parallel.

12. The reactor system according to claim 1, wherein the tubular reactors are part of a recirculation system.

13. The reactor system according to claim 1, wherein at least one inlet for introducing carbon dioxide into the tubular reactors is in the form of a replaceable nozzle.

14. The continuous carbonation process comprising the process steps of:
a) providing a carbonation reactant, wherein the carbonation reactant is suitable for reacting with carbon dioxide;
b) providing carbon dioxide; and
c) performing a reaction of the carbonation reactant with carbon dioxide to effect chemical binding of the carbon dioxide, wherein process step c) is performed in a reaction system according to claim 1.

15. The process according to claim 14, wherein reaction product obtained after process step c) is removed from the reaction system using a separation unit, wherein particles up to a defined size range as a constituent of the reaction stream downstream of the separation unit are reused in process step c).

16. The use of a reactor system according for a continuous carbonation process comprising a plurality of substantially vertically arranged tubular reactors for performing a carbonation reaction, wherein the tubular reactors are operable at a pressure of ≥1 bar and wherein the tubular reactors comprise at least one media inlet through which a reaction mixture is introducible into the tubular reactors that are at a pressure of ≥1 bar, wherein the reactor system comprises at least one inlet for introducing carbon dioxide into the tubular reactors and wherein the reactor system comprises a separation unit for substance and/or phase separation of a reaction mixture issuing from the tubular reactor or of a process according to claim 14 for the production of paints, cement or cement substitutes, of fillers, especially for paper products, polymer products or for concrete, or of products for roadbuilding.

17. The use of a reactor system according for a continuous carbonation process comprising a plurality of substantially vertically arranged tubular reactors for performing a carbonation reaction, wherein the tubular reactors are operable at a pressure of ≥1 bar and wherein the tubular reactors comprise at least one media inlet through which a reaction mixture is introducible into the tubular reactors that are at a pressure of ≥1 bar, wherein the reactor system comprises at least one inlet for introducing carbon dioxide into the tubular reactors and wherein the reactor system comprises a separation unit for substance and/or phase separation of a reaction mixture issuing from the tubular reactor or of a process according to claim 15 for the production of paints, cement or cement substitutes, of fillers, especially for paper products, polymer products or for concrete, or of products for roadbuilding.
